(19) United States
(12) Patent Application Publication
(10) Pub. No.: US 2004/0039851 A1
(43) Pub. Date: Feb. 26, 2004

(54) Universal serial bus interface memory controller and associated memory

(76) Inventors: Jerry Tang, Taipei (TW); Charlie Han, Hsinchu (TW); Jerry Jaw, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/065,300

(22) Filed: Oct. 1, 2002

(30) Foreign Application Priority Data
Aug. 23, 2002 (TW) 91119091

(51) Int. Cl. G06F 3/00

(52) U.S. Cl. 710/5

(57) ABSTRACT

A memory controller and associated memory device having a universal serial bus (USB) interface thereon. The memory controller receives a USB instruction via the USB interface. After decoding the USB instruction, the memory controller controls the flow of data to and from a coupled memory unit. The memory unit may contain read-only-memory, one time programmable memory or static random access memory by selection.

### CROSS REFERENCE TO RELATED APPLICATIONS

This application claims the priority benefit of Taiwan application serial no. 91119091, filed Aug. 23, 2002.

### BACKGROUND OF INVENTION

1. Field of Invention

The present invention relates to a memory controller and associated memory. More particularly, the present invention relates to a universal serial bus (USB) interface memory controller and associated memory.

2. Description of Related Art

The universal serial bus (USB) is a connection interface for peripheral devices mainly used in a host computer system such as a desktop computer, a notebook computer and a personal digital assistant (PDA). Due to its hot-plugging characteristic, the universal serial bus permits a user to add or remove a peripheral device at any time. The add-on or removed peripheral device is automatically detected so that the desktop, notebook or PDA can continue to operate normally. Hence, the USB interface is widely used for hooking up with peripheral devices such as a keyboard, mouse, network card and printer. Furthermore, due to the convenience of plugging a peripheral device into or removing the peripheral device from a USB interface, a storage device that uses the USB interface has also been developed for transferring or sharing data between different computers.

FIG. 1 is a schematic block diagram of a conventional hard drive with a USB interface. As shown in FIG. 1, the hard drive 100 has a standard IDE hard disk 120 that uses a USB/IDE bridge controller 110 to convert IDE interface data into USB interface format. The hard drive 100 with USB interface provides a lot of memory storage capacity for operating a USB interface. However, the hard drive 100 is a rather bulky device and also vulnerable to shock and vibration. Hence, a hard drive is in general quite unsuitable to serve as a storage medium inside common portable devices for storage of electronic books, an electronic dictionary and MP3 musical files.

### SUMMARY OF INVENTION

Accordingly, one object of the present invention is to provide a memory controller and associated memory with a universal serial bus (USB) interface that serves as a mobile storage device capable of administering data universally and reliably.

To achieve these and other advantages and in accordance with the purpose of the invention, as embodied and broadly described herein, the invention provides a memory device with a universal serial bus thereon. The memory device includes a memory unit and a memory controller. The memory unit is capable of holding electronic book data, electronic dictionary data, MP3 music files and program data. The memory can be a read-only memory (ROM), a one time programmable memory (OTP) or a static random access memory (SRAM). The memory controller is coupled to the memory unit and has a universal serial bus (USB) interface for receiving USB instructions, decoding the instructions, and executing and responding to the decoded instructions so that data is transferred into or out of the memory unit.

In one embodiment of this invention, the memory controller of the memory device includes a universal serial bus (USB) interface unit, a memory interface unit, a buffer region and a control logic unit. The USB interface unit receives a USB instruction, decodes the instruction, converts the USB instruction into a USB request, transfers the USB request to the control logic unit and responds to the execution result of the USB instruction. The memory interface unit serves as an interface for accessing the data stored inside the memory unit. The buffer region is coupled to the USB bus interface corresponds to the memory unit. The control logic unit is coupled to the buffer region, the USB interface unit and the memory interface unit for receiving the USB request to control the execution of the USB instruction and to respond to the execution result.

The USB interface unit supports various universal serial bus specifications including the USB 1.0, USB 1.1 and USB 2.0. The buffer region comprises a plurality of buffers that supports interleaved access to boost access performance. The control logic unit may further include a micro-controller having a read-only-memory unit therein for holding execution program codes of the USB instructions. Moreover, the control logic unit is capable of providing data security functions or buffer cache functions.

In this invention, portable and easy-to-control memory such as read-only-memory, one time programmable memory or static RAM is used to store data such as electronic book data, electronic dictionary data, MP3 music files, multi-media files, and electronic files. When combined with a high performance memory controller, this invention provides a highly portable and highly accessible mobile storage device for data.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic block diagram of a conventional hard drive with a USB interface;

FIG. 2 is a schematic block diagram of a memory device with a USB interface

FIG. 3 is a schematic block diagram of a memory controller with a USB interface thereon according to the preferred embodiment of this invention.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

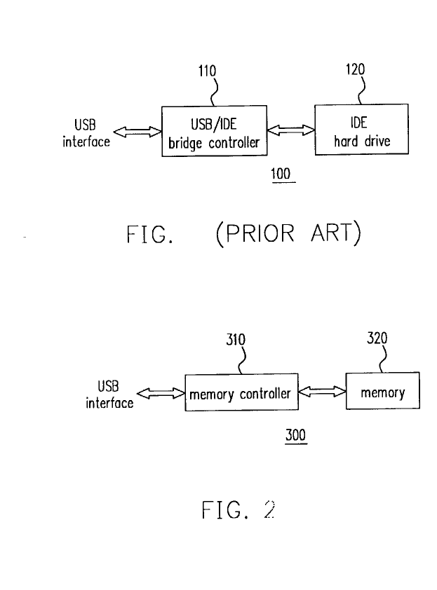

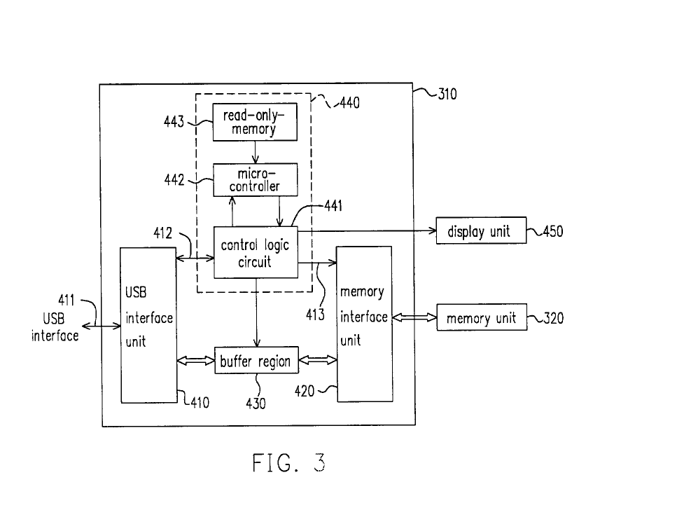

FIG. 2 is a schematic block diagram of a memory device with a USB interface thereon according to the preferred embodiment of this invention. As shown in FIG. 2, the memory device 300 includes a memory unit 320 and a memory controller 310. The memory unit 320 is used for holding data such as electronic book data, electronic dictionary data, MP3 music files, multi-media files, electronic bulletins or programs. Portable and economical memory such as read-only-memory (ROM), one time programmable (OTP) memory or static random access memory (SRAM) is used inside the memory unit 320. The memory controller 310 having a USB interface thereon is coupled to the memory unit 320 for receiving USB instructions, decoding the instructions, and executing and responding to the USB instructions so that data within the memory unit 320 may be accessed.

FIG. 3 is a schematic block diagram of the memory controller 310 in FIG. 2. As shown in FIG. 3, the memory controller 310 includes a universal serial bus (USB) interface unit 410, a memory interface unit 420, a buffer region 430 and a control logic unit 440. The control logic unit 440 further includes a control logic circuit 441, a micro-controller 442 and a read-only-memory (ROM) unit 443. The ROM unit 443 holds program codes for operating the micro-controller 442 so that the micro-controller 442 may control the control logic circuit 441 to receive USB instructions 411 and execute those instructions accordingly. The following is a more detailed description of the functions carried out by each block in FIG. 3.

First, the USB interface unit 410 receives a USB instruction 411 through the USB interface. The USB instruction 411 is next decoded and then converted into a USB receiving the USB request 412, the control logic unit 440 analyzes the request 412 to determine the type USB instruction 411 it represents. Thereafter, the control logic unit 440 executes necessary programs and responds to the execution results according to the type of USB instruction 411 detected.

For example, when the USB interface unit 410 picks up a USB instruction 411 for reading data from the memory unit 320, a USB request 412 for reading from the memory unit 320 is issued. On receiving the USB request 412, the control logic unit 440 inspects the buffer region 430 to determine if the request data is already there. If the desired data has already been transferred into the buffer region 430, that is, a cache hit event has occurred, the USB interface unit 410 is triggered to read the data from the buffer region 430 in response to the program execution of the USB instruction 411. Conversely, if the desired data is outside the buffer region 430, that is, a cache miss has occurred, the control logic unit 440 will issue a memory command 413 so that the requested data is transferred into the buffer region 430 from the memory unit 320 via the memory interface unit 420. Afterwards, the USB interface unit 410 is triggered to read the data from the buffer region 430 in response to the program execution of the USB instruction 411.

The aforementioned description is an example of the control logic unit 440 supporting the buffer region as a functional data cache. However, anyone familiar with such technologies may use the following scheme as a means to boost system performance. If accessing efficiency is not a major consideration, there is no need to look for a data match or a data mismatch in the storage area first. Instead, the desired data may be directly transferred from the memory unit 320 to the buffer region 430 and then the USB interface unit 410 can be triggered to read the data from the buffer region 430 in response to the program execution of the USB instruction 411. In other words, the buffer region does not need to have a cache function.

In addition, if the memory unit 320 contains read/write static random access memory (SRAM), and a write USB request 412 is issued when the USB interface unit 410 picks up a USB instruction 411 for writing data into the memory unit 320, on receiving the USB request 412, the control logic unit 440 controls the USB interface execution of the USB instruction 411. The control logic unit 440 also redirects the writing of the data from the buffer region 430 into the memory unit 320 via the memory interface unit 420 by stages.

The USB interface unit 410 supports various USB specifications including the USB 1.0, the USB 1.1 and the USB 2.0. The buffer region 430 may include a single or a multiple of buffers such as FIFO or RAM buffers to facilitate the storage of a corresponding portion of the address data inside the memory unit 320. Furthermore, if the buffer region 430 has a plurality of buffers, system performance may be improved by operating in an interleaved access mode.

In addition, the control logic unit 440 may support other functions such as a data security check. For example, a set portion of the addresses inside the memory unit 320 may be locked or unlocked. When a set portion of the addresses inside the memory unit is locked, reading data from the locked section is permitted. However, any attempt to write data into the locked section is immediately rejected. To provide the user with additional system information such as power on or memory read/write in progress, the control logic unit 440 may issue signals to an external display unit 450 and light up a display such as an LED to indicate such status.

In summary, the memory device according to this invention permits the selection of portable and low-cost memory including ROM, OTP or SRAM for holding data such as electronic book data, electronic dictionary data, MP3 music files, multi-media files or electronic bulletin files. When combined with a highly efficient memory controller, this invention provides a highly portable and highly accessible mobile storage device for holding common data.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A memory controller having a universal serial bus (USB) interface; comprising:
a USB interface unit for receiving a USB instruction, decoding the instruction and converting the USB instruction to a USB request and responding to the USB instruction;
a memory interface unit serving as an interface with a memory unit, wherein the memory unit can be a read-only-memory, a one time programmable memory or a static random access memory;
a buffer region coupled to the USB interface unit and the memory interface unit for holding data corresponding to that portion of the address in the memory unit; and
a control logic unit coupled to the buffer region, the USB interface unit and the memory interface unit for receiving the USB request, executing and responding to the USB request.

2. The memory controller of claim 1, wherein the USB interface unit supports universal serial bus protocols including USB1.0, USB1.1 and USB2.0.

3. The memory controller of claim 1, wherein the buffer region has a plurality of buffers and supports interleaved access.

4. The memory controller of claim 1, wherein the control logic unit further includes a micro-controller.

5. The memory controller of claim 1, wherein the control logic unit supports a data security function.

6. The memory controller of claim 1, wherein the control logic unit supports a buffer region data cache function.

7. A memory device having universal serial bus (USB) interface, comprising:
a memory unit for holding data, wherein the memory unit can be read-only-memory, one time programmable memory or static random access memory; and
a memory controller coupled to the memory unit having a USB interface for receiving a USB instruction, decoding, executing and responding to the USB instruction so that data can be accessed.

8. The memory device of claim 7, wherein the memory controller further includes:
a USB interface unit for receiving a USB instruction, decoding the instruction and converting the USB instruction to a USB request and responding to the USB instruction;
a memory interface unit serving as an interface with a memory unit;
a buffer region coupled to the USB interface unit and the memory interface unit for holding data corresponding to that portion of the address in the memory unit; and
a control logic unit coupled to the buffer region, the USB interface unit and the memory interface unit for receiving the USB request, executing and responding to the USB request.

9. The memory device of claim 8, wherein the USB interface unit supports universal serial bus protocols including USB1.0, USB1.1 and USB2.0.

10. The memory device of claim 8, wherein the buffer region has a plurality of buffers and supports interleaved access.

11. The memory device of claim 8, wherein the control logic unit includes a micro-controller.

12. The memory device of claim 8, wherein the control logic unit supports a data security function.

13. The memory device of claim 8, wherein the control logic unit supports a buffer region data cache function.
